(19) United States
(12) Patent Application Publication
(10) Pub. No.: US 2006/0021486 A1
(43) Pub. Date: Feb. 2, 2006

(54) Slitter set up for an automatic blade change

(75) Inventor: Rudolf Supe-Dienes, Overath (DE)

Correspondence Address: SUGHRUE MION, PLLC, 2100 PENNSYLVANIA AVENUE, N.W., SUITE 800, WASHINGTON, DC, 20037, US

(73) Assignee: DIENES WERKE

(21) Appl. No.: 10/903,250

(22) Filed: Aug. 2, 2004

(30) Foreign Application Priority Data
Jul. 31, 2003 (DE) 203 11 973.8

(51) Int. Cl. B26D 1/12

(52) U.S. Cl. 83/663

(57) ABSTRACT

A slitter with several cutting units connected to it each in the form of a blade holder (11) as a support stand for a circular blade (13). A device (19), which is provided for changing the cutting units (13) automatically, comprises a stack (16) for stocking at least one new cutting unit and an automatic tooling layout (17) for dismounting the used cutting unit and for mounting the new cutting unit (13) taken out of the stack.

### DESCRIPTION

The invention relates to a slitter with several cutting units attached to it each in the form of a blade holder as a support stand for a circular blade that is placed on it.

The problem with machines of this type is that the process of changing the circular blade on each individual blade holder is time-consuming because the circular blade on the respective blade holder is required to be dismounted by hand followed by the mounting of a new blade. The attachment of the blades to the cutter head of the blade holder by means of e.g., appropriately designed blade attachment parts has a suitable layout, thus reducing the costs and efforts required for mounting and dismounting. However, the design of the machine calls for manual operation. The required manual operation results in considerably high set-up time for the blade change particularly in case of the blade holders that are arranged on the slitter at a small distance to each other.

Therefore the task underlying the invention is to design a slitter of the aforementioned type such that it reduces the set-up time required for blade replacement.

This task is solved by the invention together with its advantageous arrangements and designs and the content of the claims that follow the description of the invention.

The fundamental idea of the invention is to provide a device for changing the cutting unit automatically that comprises a stack for stocking at least one new cutting unit and an automatic tooling arrangement for dismounting the used cutting unit. The inventive idea is represented by the fact that a device is provided on the slitter that on receiving a control command automatically replaces one or more cutting units and for this purpose carries along the new cutting unit and/or cutting units to be mounted into a stack. At the same time the device can with the help of an automatic tooling arrangement, dismount the respective used cutting unit and replace it with a new cutting unit. Thus the invention presents the advantageous option of equipping the stack of the device with the required number of cutting units independent of the work cycle of the slitter, such that the new cutting units are available for the automatic replacement process.

According to an embodiment of the invention the device includes as an interchangeable part of the cutting unit only the blade that is mounted on the blade holder, such that only individual blades have to be carried along into the stack and stocked for the operation and handling.

Alternatively, the device can include as interchangeable parts of the respective cutting units, the blade together with the blade attachment parts that are connected to the blade and serve for mounting the blade on the blade holder. Another alternative is for the device to include as an interchangeable part of the cutting unit, the complete cutter head that is mounted on the blade holder as a support stand of the blade. In an appropriate adjustment, each of the stacks that are carried along by the device must be designed appropriately in order to collect the interchangeable parts and the tooling layout must be arranged corresponding to the dismounting and/or mounting process of the respective interchangeable part.

According to another embodiment of the invention, the device, particularly one that moves along the length of the slitter, can include as an interchangeable part of the cutting unit, the blade holder that is connected to the slitter, such that this embodiment represents the idea of the invention to change the complete blade holder. This proves to be even easier mechanically than changing an individual circular blade. It is by all means possible to carry along a number of blade heads into an appropriately designed stack. This embodiment of the invention presents the option of not just a blade change but also of depth adjustment on the blade holder and maintenance of the blade holder.

In a first embodiment of the invention, the device comprises a rotating cantilever arm that is mounted on each blade holder between a working position that is suitable for changing the circular blade and a mounting position. The stack together with the tooling layout for the blade change is fixed to the outer end of the cantilever arm. In this embodiment for each blade holder, only one interchangeable part needs to be provided in the stack in the form of a blade or a blade together with blade attachment parts or a cutter head. This is because the respective interchangeable part can be inserted into the stack for the next replacement process after every blade change and swiveling of the cantilever arm into the mounting position independent of the continuing cutting operation of the slitter.

In an alternative embodiment, the stack with the tooling layout can move along an attached crossbeam. If the stack is located at a distance from the blade holder the tooling layout can be driven by means of a piston rod, into a working position that is suitable for the replacement of the parts. In such an embodiment of the invention, the device can be designed such that the replacement process can take place on several blade holders in a sequence, wherein the stack must be arranged so as to facilitate a collection of several replacement parts. Also the tooling layout must be set up suitably not only for the mounting and dismounting of the replacement part but also for the removal of the replacement parts from the stack and delivery of the used parts into the stack.

In another embodiment of the invention, the device is mounted on a slide that is moveable along the slitter and a moving cantilever arm is arranged on the slide between a working position that is suitable for replacing the cutting unit and a mounting position. The stack together with the tooling layout is fixed to the edge of the cantilever arm. In this embodiment the cantilever arm is arranged on the slide such that it can swivel. In this case also, the stack and the tooling layout are set up appropriately for a multiple replacement of parts.

The figures described below illustrate the embodiments of the invention. Shown are:

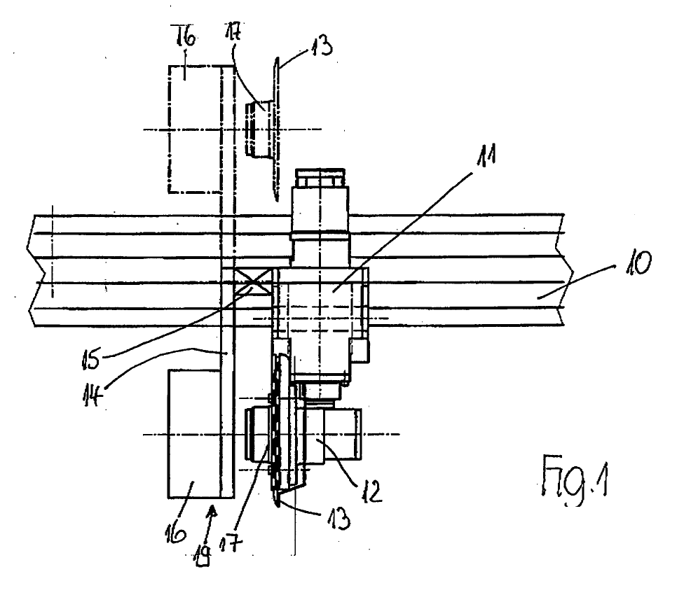

FIG. 1 the schematic side view of a blade holder that is mounted on a slitter with a circular blade and an attached device for blade replacement,

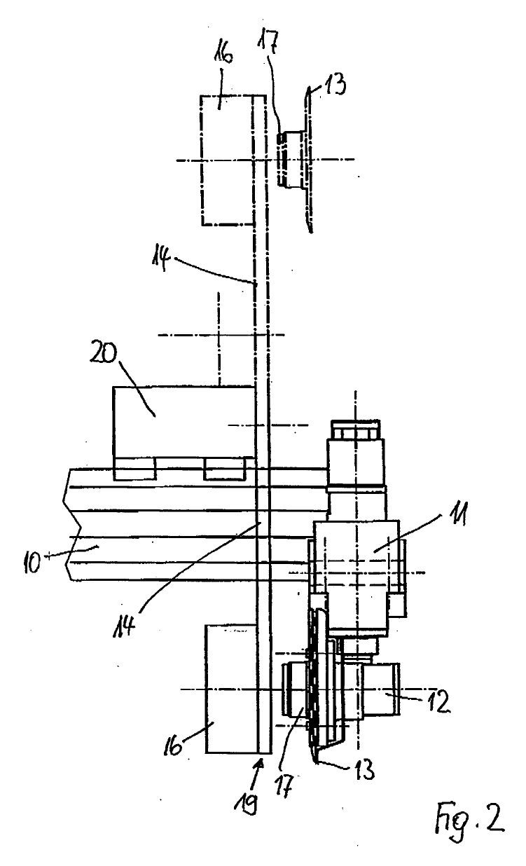

FIG. 2 A first embodiment of the object illustrated in FIG. 1.

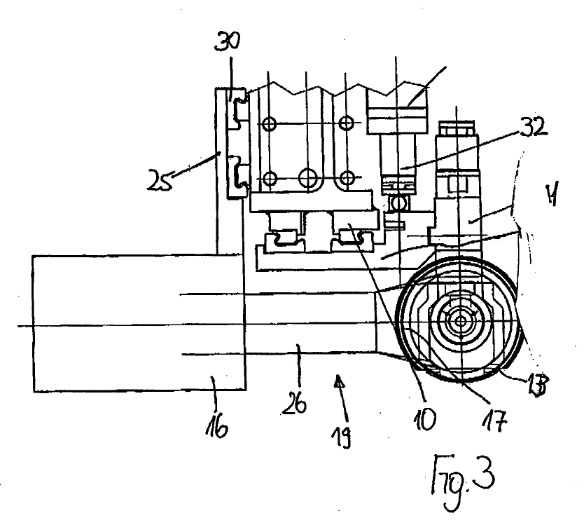

FIG. 3 A second embodiment of the object illustrated in FIG. 1.

The invention is described on the basis of the following embodiments relating to the replacement of the circular blade on the cutter head of a blade holder. Even the cutter head and the complete blade holder can be the object of the replacement process.

A blade holder 11 is arranged on the crossbeam 10 of a slitter that is not illustrated in the figures. The blade holder 11 carries a cutter head 12 on the side of which a circular blade 13 is mounted. As a device 19 for an automatic blade change, a cantilever arm 14 that swivels around a pivot bearing 15 is arranged on the blade holder 11. At the outer end of the cantilever arm 14, a stack 16 is arranged that is connected with a moving tooling layout 17 for an automatic blade change. The solid line in FIG. 1 indicates the working position of the stack 16 with the tooling layout 17 in which it is possible by means of a suitable design of the tooling layout 17 to dismount the circular blade 13 and subsequently mount a new circular blade that is removed from the stack 16. The dotted lines indicate the position of the cantilever arm 14 after it swivels into a mounting position in which during the cutting operation the used circular blade can be removed from the stack 16 and replaced by a new circular blade, which then becomes available for a repeat replacement by the swiveling of the cantilever arm 14 into the working position indicated by the solid lines.

In the embodiment illustrated in FIG. 2, the cantilever arm 14 including the stack 16 and the tooling layout 17 are mounted on a moveable slide 20 that is arranged on the crossbeam 10 of the slitter wherein the slide 20 can leave from several blade holders 11 one after the other and perform the corresponding blade change. In doing so, the cantilever arm can be swiveled after an implemented blade change such that each equipped blade holder 11 can be traversed and the cantilever arm 14 obtains access to the next blade holder. By designing the tooling layout 17 in a manner that is not illustrated in the figures, it must be ensured that at each time several knives from the stack 16 . . .

[Sentence appearing at the end of the source document (page 6) is incomplete.]

1. Slitter with several cutting units connected to it each in the form of a blade holder (11) as a support stand for a circular blade (13) that is placed on it, in which a device (19) is provided for changing the cutting units (13) automatically. This device (19) comprises a stack (16) for stocking at least one new cutting unit and an automatic tooling layout (17) for dismounting the used cutting unit and for mounting the new cutting unit (13) taken out of the stack.

2. Slitter in accordance with claim 1 in which the device (19) includes the blade that is connected to the blade holder (11) as an interchangeable part of the cutting unit.

3. Slitter according to claim 1 in which the device (19) includes the blade together with the blade attachment parts that are connected to the blade and that serve for attaching the blade to the blade holder (11) as an interchangeable part of the cutting unit.

4. Slitter according to claim 1, in which the device includes the complete cutter head (12) that is connected to the blade holder (11) as a support stand of the blade as an interchangeable part of the cutting unit.

5. Slitter according to claim 1 in which the device includes the blade holder (11) that is connected to the slitter as an interchangeable part of the cutting unit.

6. Slitter in accordance with one of the claims 1 to 4 in which the device (19) comprises a rotating cantilever arm (14) that is mounted on each blade holder (11) between a working position that is suitable for changing the circular blade (13) and a mounting position. The stack (16) with the tooling arrangement (17) for the blade change is fixed to the outer end of the cantilever arm (14).

7. Slitter in accordance with one of the claims 1 to 5 in which the stack (16) with the tooling arrangement (17) is moveable along an attached crossbeam (30).

8. Slitter in accordance with claim 6 in which the tooling layout (17) can be extended by means of a piston rod (26) from the stack (16), which is located at a distance from the blade holder (11) into a working position that is suitable for changing the cutting unit.

9. Slitter in accordance with one of the claims 1 to 5 in which the device (19) is mounted on a slide (20) that is moveable along the slitter. A moving cantilever arm (14) is arranged on the slide (20) between a working position that is suitable for changing the cutting unit and a mounting position. The stack (16) with the tooling layout (17) is fixed to the end of the cantilever arm (14).

10. Slitter in accordance with claim 9 in which the cantilever arm (14) is arranged on the slide (20) such that it can swivel.
